(19) United States
(12) Patent Application Publication
(10) Pub. No.: US 2012/0131291 A1
(43) Pub. Date: May 24, 2012

(54) APPLICATION AWARE SNAPSHOTS

(75) Inventors: Gaurav B. Gangalwar, Maharashtra (IN); Rahul C. Khali, Pune (IN); Praveen K. Padia, Pune (IN); Rohit Shekhar, Pune (IN)

(73) Assignee: INTERNATIONAL BUSINESS MACHINES CORPORATION, Armonk, NY (US)

(21) Appl. No.: 12/949,872

(22) Filed: Nov. 19, 2010

(51) Int. Cl. G06F 12/16

(52) U.S. Cl. 711/162; 711/E12.103

(57) ABSTRACT

A method of creating an application aware snapshot comprises a host system receiving a request for a snapshot, and the host system sending a SCSI snapshot command directly to a disk controller without requiring a disk controller-specific provider to be installed on the host system. The disk controller then receives the SCSI snapshot command and creates the snapshot in response to receiving the SCSI command, wherein the snapshot is created in accordance with logic contained within the disk controller without requiring a disk controller-specific provider to be installed on the host system. Using the SCSI snapshot command facilitates a plurality of host systems being able to send a SCSI snapshot command directly to a disk controller without requiring a disk controller-specific provider to be installed on each of the plurality of host systems. Similarly, a single host system is able to send a SCSI snapshot command directly to a plurality of disk controllers without requiring a disk controller-specific provider for each disk controller to be installed on the host system.

### BACKGROUND

1. Field of the Invention

The present invention relates to application aware snapshots of memory.

2. Background of the Related Art

In computer systems, it is necessary to provide systems and methods to protect data against corruption and make backups of data so that a system can recover from any data corruption that might occur. One method used for data protection and backup is known as a “snapshot.” Unlike a full backup of a data set that may take a long time to complete, a snapshot can be created very quickly and allow applications to continue writing to their data. The snapshot may involve the creation of a read-only copy of the data at a particular instant in time. A beneficial aspect of a snapshot is that a large amount of data does not require a proportional amount of time and input/output bandwidth. Still further, after an initial snapshot of data has been created, a further snapshot of that data may include only the data that changed since the initial snapshot and a reference to the initial snapshot.

Most disk controllers provide a way to create a snapshot that can be used as a source for a backup. However, such snapshots are likely to be inconsistent since applications may have their own cache of modified data which are yet to be flushed to disk. In order to take a consistent snapshot in a disk controller, it is necessary to have a mechanism to force applications to flush modified data in their respective caches. Such disk controller mechanisms may be either manual or automated.

In the manual method of flushing the cache to disk, an administrator will pause all applications and then execute an application-specific flush command for each application. The administrator may then instruct the disk controller to take a snapshot and, upon completion of the snapshot, resume operation of the application.

In the automated method of flushing the cache to disk, a disk controller provider (that is specific to the particular disk controller) must be installed on the host system, such that the provider process can be called by the host system when a snapshot is requested by a user or an application. In addition, the applications that are using the disk controller are required to register with a host system component. When a snapshot request is communicated with the host system component, the host system component automatically communicates with each of the registered applications (those applications that are using the disk) and instructs each application to quiesce and flushes its cached data. Then, the host system component calls the disk controller-specific provider associated with a particular disk drive to request the creation of a snapshot. The provider installed on the host system communicates with the disk controller over a systems management path to execute a non-standard, disk controller-specific method to create the snapshot. After the snapshot has been created, the host system component instructs each application that was previously using the disk to unquiesce and resumes operation. A similar approach is believed to be implemented by Microsoft VSS framework. The disadvantage of this approach is the requirement of installing a disk controller-specific provider on the host system. Because the provider is specific to a particular disk controller (i.e., a different provider is needed for various brands, models, versions, etc.), it is not easy to deploy storage from a new storage vendor. Also, such a provider must be developed for each type of host where the provider may need to be installed, such as Unix flavours, Windows, Vmware etc.

For the purpose of illustration, one method of snapshot creation is referred to as a “copy on write” (COW) method. There are multiple ways to implement a COW snapshot, and it should be recognized that the following example is only one such method. After the applications' input/output has been quiesced and all the cached data (disk controller's cache) has been flushed into disk, then the disk controller can begin creating a snapshot volume under the direction of the disk controller specific provider installed on the host system. The new snapshot volume relates back to the source volume for which the snapshot has been created. At the time that a COW snapshot is created, it is not necessary to write anything into the snapshot volume. Rather, when a write request is directed to the source volume, the disk controller will first check to determine if a snapshot has been created for this volume. If a snapshot has been created, then the disk controller will check to see if the snapshot volume contains data on the blocks which are going to be modified as a result of the write request. If the data is not yet present on the snapshot volume, the disk controller will copy the content of the blocks from the source volume to the snapshot volume. Those blocks that are copied are then marked as populated in the snapshot volume block map. Then, the disk controller will go ahead and modify the blocks in the source volume in accordance with the write request. In this manner, only the data that is going to be modified by a write request is copied in the snapshot volume at the time of modification. For all the un-modified data, the source volume contains the only copy. Still further, if a read request is directed to the snapshot volume, such as by a backup application, the disk controller will first determine whether the snapshot volume contains the block for which the read is requested. If the snapshot volume contains the relevant block, the read request will be performed based on the data present in snapshot volume. If the relevant block is not in the snapshot volume, then the source data is read for that block. It should be recognized that the fact that the snapshot volume is not populated for that block indicates that the source data still contains the unmodified data for that block. The snapshot volume may be read only (for back up purpose) or can be read-write based on usage.

### BRIEF SUMMARY

One embodiment of the present invention provides a method of creating an application aware snapshot. The method comprises a host system receiving a request for a snapshot, and the host system sending a SCSI snapshot command directly to a disk controller without requiring a disk controller-specific provider to be installed on the host system. The disk controller then receives the SCSI snapshot command and creates the snapshot in response to receiving the SCSI command, wherein the snapshot is created in accordance with logic contained within the disk controller without requiring a disk controller-specific provider to be installed on the host system.

Another embodiment of the invention provides a method of creating an application aware snapshot. The method begins with a host system receiving a request for a snapshot. Then, the host system sends a first instance of a SCSI snapshot command directly to a first disk controller without requiring a disk controller-specific provider to be installed on the host system. The first disk controller receives the SCSI snapshot command and creates a first snapshot in response to receiving the SCSI command, wherein the first snapshot is created in accordance with logic contained within the first disk controller without requiring a disk controller-specific provider to be installed on the host system. Similarly, the host system may send a second instance of a SCSI snapshot command directly to a second disk controller without requiring a disk controller-specific provider to be installed on the host system. The second disk controller receives the SCSI snapshot command and creates a second snapshot in response to receiving the SCSI command, wherein the second snapshot is created in accordance with logic contained within the second disk controller without requiring a disk controller-specific provider to be installed on the host system.

### BRIEF DESCRIPTION OF THE SEVERAL VIEWS OF THE DRAWINGS

FIG. 1 is a schematic diagram of a host system in communication with two different disk drives in accordance with the present invention.

FIG. 2 is a flowchart of a method of creating an application aware snapshot.

### DETAILED DESCRIPTION

One embodiment of the present invention provides a first method of creating an application aware snapshot. The method comprises a host system receiving a request for a snapshot, and the host system sending a SCSI snapshot command directly to a disk controller without requiring a disk controller-specific provider to be installed on the host system. The disk controller then receives the SCSI snapshot command and creates the snapshot in response to receiving the SCSI command, wherein the snapshot is created in accordance with logic contained within the disk controller without requiring a disk controller-specific provider to be installed on the host system.

Another embodiment of the invention provides a second method of creating an application aware snapshot. The method begins with a host system receiving a request for a snapshot. Then, the host system sends a first instance of a SCSI snapshot command directly to a first disk controller without requiring a disk controller-specific provider to be installed on the host system. The first disk controller receives the SCSI snapshot command and creates a first snapshot in response to receiving the SCSI command, wherein the first snapshot is created in accordance with logic contained within the first disk controller without requiring a disk controller-specific provider to be installed on the host system. Similarly, the host system may send a second instance of a SCSI snapshot command directly to a second disk controller without requiring a disk controller-specific provider to be installed on the host system. The second disk controller receives the SCSI snapshot command and creates a second snapshot in response to receiving the SCSI command, wherein the second snapshot is created in accordance with logic contained within the second disk controller without requiring a disk controller-specific provider to be installed on the host system.

Another embodiment of either the first or second method, further comprises the host system communicating with each application that is using the disk, wherein the communication instructs each application to quiesce and flush any cached data to the disk. This step is preferably performed prior to creating the snapshot, so that the snapshot will include all of the relevant data. After the disk controller reports to the host system that the snapshot has been created, then the host system instructs each application to resume operation.

According to a further embodiment of either the first or second method, a plurality of host systems are able to send a SCSI snapshot command directly to a disk controller without requiring a disk controller-specific provider to be installed on each of the plurality of host systems. In a still further embodiment of the first or second method, the host system is able to send a SCSI snapshot command directly to a plurality of disk controllers without requiring a disk controller-specific provider for each disk controller to be installed on the host system.

The present invention enhances the existing SCSI protocol, which has not previously included a snapshot command. Implementing the new SCSI snapshot command enables the creation of an application aware snapshot without requiring the installation of a disk controller-specific provider on the host system. However, the disk controller must be able to create the application aware snapshot in response to receiving the SCSI snapshot command. A further benefit of using the new SCSI snapshot command is that a plurality of host systems can use the single SCSI snapshot command to initiate an application aware snapshot with any of a plurality of storage devices, including storage devices that are recently added to the system without installing a disk controller specific provide on each host system.

It should be recognized that the present invention does not dictate how the disk controller should create the snapshot. Rather, the disk controller is modified to understand the new SCSI command for requesting a snapshot, but may use any disk-specific method of creating the snapshot. It should be recognized that the use of the standard SCSI command does not standardize how the snapshot is created, but rather standardizes how to initiate the creation of an application aware snapshot. Unlike some vendor-specific solutions available, the SCSI command is completely I/O path based and, unlike management path based communications, does not need higher level execution in order to achieve an application aware snapshot.

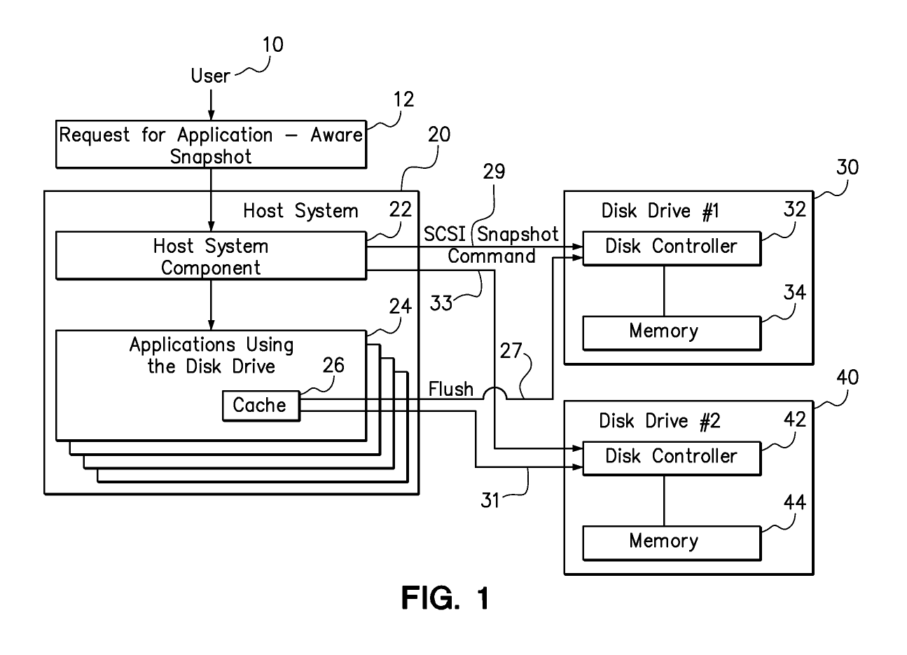

FIG. 1 is a schematic diagram of a host system 20 in communication with two different disk drives 30, 40 in accordance with the present invention. A user 10 sends a request for an application aware snapshot 12 to the host system component 22 comprising the host system hardware, an operating system running on the hardware, and applications running on the operating system. The host system component 22 is in communication with the applications 24 that are using the disk drives. Each application 24 may have its own portion of cache memory 26 (typically allocated to the application from the processor chip). In response to the host system component 22 receiving the snapshot request, the host system component 22 communicates with the applications 24 that are using the disk for which a snapshot is to be made. In this example, let's assume that the request is to take a snapshot of disk drive #1 (30). The communication instructs the applications 24 to quiesce input/output with the disk 30 and to flush their cache (see line 27) memory 26 to the disk 30. Separately, the host system component 22 sends a SCSI snapshot command (see line 29) to the disk controller 32 for the disk drive 30. Accordingly, the disk controller 32 performs its own process for preparing the snapshot with respect to the memory 34. Once the snapshot has been completed, the disk controller 32 reports this fact to the host system component 22, which then instructs the applications 24 to resume operations. If the snapshot request had been directed to disk drive #2 (40), then the same method would be used, except that the method might affect a different set of applications 24, the cache 26 would be flushed (see line 31) to the disk drive #2 (40), and the SCSI snapshot command would be sent to the disk controller 42 (see line 33). Additional disk drives could be similarly connected, and additional host systems could be connected to communicate with the disk drives.

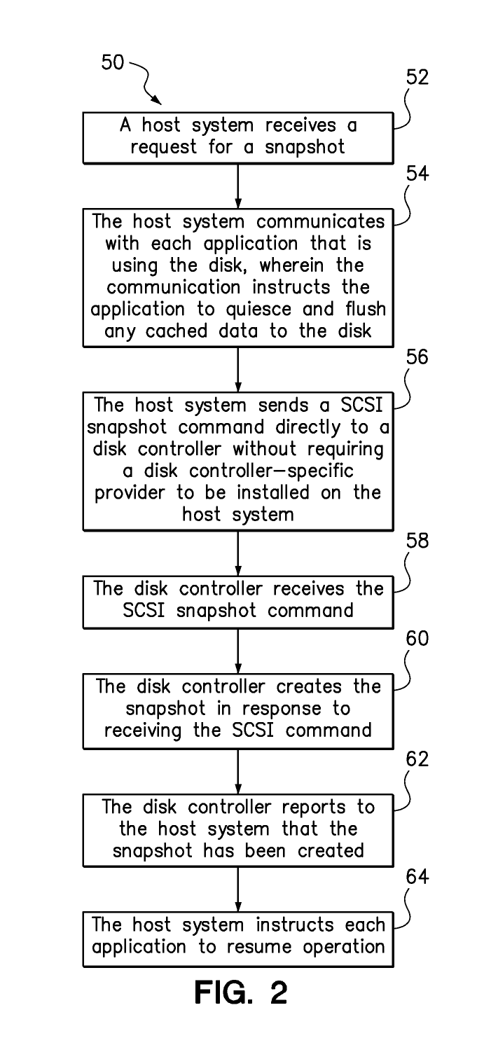

FIG. 2 is a flowchart of a method 50 of creating an application aware snapshot. In step 52, a host system receives a request for a snapshot. Then, in step 54, the host system communicates with each application that is using the disk, wherein the communication instructs each of those applications to quiesce and flush any cached data to the disk. In step 56, the host system sends a SCSI snapshot command directly to a disk controller without requiring a disk controller-specific provider to be installed on the host system. The disk controller receives the SCSI snapshot command in step 58, creates the snapshot in response to receiving the SCSI command in step 60, and reports to the host system that the snapshot has been created in step 62. Then, in step 62, the host system instructs each application to resume operation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of creating an application aware snapshot, comprising:
a host system receiving a request for a snapshot;
the host system sending a SCSI snapshot command directly to a disk controller without requiring a disk controller-specific provider to be installed on the host system;
the disk controller receiving the SCSI snapshot command and creating the snapshot in response to receiving the SCSI command, wherein the snapshot is created in accordance with logic contained within the disk controller without requiring a disk controller-specific provider to be installed on the host system.

2. The method of claim 1, further comprising:
the host system communicating with each application that is using the disk, wherein the communication instructs the application to quiesce and flush any cached data to the disk;
the disk controller reporting to the host system that the snapshot has been created; and then
the host system instructing each application to resume operation.

3. The method of claim 1, wherein a plurality of host systems are able to send a SCSI snapshot command directly to a disk controller without requiring a disk controller-specific provider to be installed on each of the plurality of host systems.

4. The method of claim 1, wherein the host system is able to send a SCSI snapshot command directly to a plurality of disk controllers without requiring a disk controller-specific provider for each disk controller to be installed on the host system.

5. A method of creating an application aware snapshot, comprising:
a host system receiving a request for a snapshot;
the host system sending a first instance of a SCSI snapshot command directly to a first disk controller without requiring a disk controller-specific provider to be installed on the host system;
the first disk controller receiving the SCSI snapshot command and creating a first snapshot in response to receiving the SCSI command, wherein the first snapshot is created in accordance with logic contained within the first disk controller without requiring a disk controller-specific provider to be installed on the host system.
the host system sending a second instance of a SCSI snapshot command directly to a second disk controller without requiring a disk controller-specific provider to be installed on the host system;
the second disk controller receiving the SCSI snapshot command and creating a second snapshot in response to receiving the SCSI command, wherein the second snapshot is created in accordance with logic contained within the second disk controller without requiring a disk controller-specific provider to be installed on the host system.

6. The method of claim 5, further comprising:
the host system communicating with each application that is using the first disk, wherein the communication instructs the applications to quiesce and flush any cached data to the first disk;
the first disk controller reporting to the host system that the snapshot has been created; and then
the host system instructing each application to resume operation.

7. The method of claim 5, wherein a plurality of host systems are able to send a SCSI snapshot command directly to the first and second disk controllers without requiring a disk controller-specific provider to be installed on each of the plurality of host systems.
